(19) United States
(12) Patent Application Publication
(10) Pub. No.: US 2015/0372551 A1
(43) Pub. Date: Dec. 24, 2015

(54) STRUCTURE OF STATOR

(71) Applicant: AISIN AW CO., LTD., Aichi (JP)

(72) Inventors: Shingo HASHIMOTO, Okazaki (JP); Masaki SAITO, Okazaki (JP)

(73) Assignee: AISIN AW CO., LTD., Aichi-ken (JP)

(21) Appl. No.: 14/765,713

(22) PCT Filed: Mar. 28, 2014
(86) PCT No.: PCT/JP2014/059130

§ 371 Date: Aug. 4, 2015

(30) Foreign Application Priority Data
Mar. 29, 2013 (JP) 2013-074559

(51) Int. Cl. H02K 3/12; H02K 3/50; H02K 3/28

(52) U.S. Cl. CPC H02K 3/12; H02K 3/28; H02K 3/50

(57) ABSTRACT

A stator including a stator core having an annular yoke, a plurality of teeth protruding in a radial direction from a radial side surface of the yoke, and slots each formed between two of the teeth which are adjacent to each other in a circumferential direction; and a plurality of stator coils disposed in the circumferential direction in the stator core, formed by a rectangular conductor having a quadrilateral section, and each having two slot portions that are accommodated in different ones of the slots, and coil end portions that protrude outward in an axial direction from axial end faces of the stator core to connect the two slot portions.

### BACKGROUND

The present disclosure relates to stators, and more particularly to structures of stators which are preferable to bond a plurality of stator coils disposed in the circumferential direction in a stator core, and having two slot portions that are formed by a rectangular conductor having a quadrilateral section and that are accommodated in different slots, and coil end portions that protrude outward in the axial direction from axial end faces of the stator core to connect the two slot portions.

Conventionally, stators including a stator core and stator coils are known in the art (see, e.g., JP 2012-125043 A). In such a stator, the stator core has an annular yoke, a plurality of teeth protruding inward in the radial direction from the inner peripheral surface of the yoke, and slots each formed between two of the teeth which adjoin each other in the circumferential direction. The plurality of stator coils are disposed in the circumferential direction in the stator core. Each stator coil has two slot portions that are accommodated in different slots, and two coil end portions that protrude outward in the axial direction from both axial end faces of the stator core. Each coil end portion connects the two slot portions located on both sides.

In the stator described in JP 2012-125043 A, each stator coil is formed so that both the slot portions and the coil end portions extend substantially linearly in the axial direction as viewed from the side. Both ends of each stator coil are bent from linear portions extending in the axial direction and extend outward in the radial direction. Both ends of each stator coil are bonded to the ends of other stator coils that are present in the circumferential direction. This bonding of the ends of the stator coils is performed at a position separated outward in the radial direction from the outer peripheral ends of the stator coils (see FIG. 3 etc.)

### SUMMARY

In the stator described in JP 2012-125043 A, however, the slot portions and the coil end portions of each stator coil are formed so as to extend substantially linearly in the axial direction as viewed from the side. The overall axial length of the stator is therefore relatively large. Accordingly, the stator may not be able to be mounted if the space that can accommodate the stator is limited. One way to reduce the overall axial length of the stator is to reduce the overall axial length of the stator cores. However, this makes it difficult to generate a desired magnetic field in the stator, which may impair stator performance.

The present disclosure was developed in view of the above circumstances, and an exemplary aspect of the present disclosure provides the structure of a stator which is capable of reducing the overall axial length without impairing performance.

According to one exemplary aspect of the present disclosure, a stator includes a stator core having an annular yoke, a plurality of teeth protruding in a radial direction from a radial side surface of the yoke, and slots each formed between two of the teeth which are adjacent to each other in a circumferential direction; and a plurality of stator coils disposed in the circumferential direction in the stator core, formed by a rectangular conductor having a quadrilateral section, and each having two slot portions that are accommodated in different ones of the slots, and coil end portions that protrude outward in an axial direction from axial end faces of the stator core to connect the two slot portions, wherein the coil end portions of each stator coil are tilted toward the yoke in the radial direction with respect to the slot portions extending in the axial direction, and one end of one of the stator coils is bonded to the other end of another one of the stator coils at such a position that is located on an opposite side of the tilted coil end portion from the yoke in the radial direction and that an axial distance from the axial end face of the stator core to the position is shorter than that from the axial end face of the stator core to a top of the coil end portion in the case where the tilted coil end portion is not tilted.

According to the present disclosure, the overall axial length can be reduced without impairing performance.

### BRIEF DESCRIPTION OF THE DRAWINGS

FIG. 1 is a perspective view of a stator according to an embodiment of the present disclosure.

FIG. 2 shows configuration diagrams of the stator of the embodiment.

FIG. 3 is a perspective view of each stator coil included in the stator of the embodiment.

FIG. 4 shows diagrams showing the state where a part of the stator coils has been attached to a stator core of the embodiment.

FIG. 5 shows diagrams showing the state where all of the stator coils have been attached to the stator core of the embodiment.

FIG. 6 shows diagrams showing a main part of the stator of the embodiment.

FIG. 7 is a diagram showing the positional relation of the main part of the stator of the embodiment.

FIG. 8 shows diagrams showing the state where a part of stator coils has been attached in a stator according to a modification of the present disclosure.

FIG. 9 shows diagrams showing the state where all of the stator coils have been attached in the stator of the modification.

FIG. 10 shows diagrams showing a main part of the stator of the modification.

### DETAILED DESCRIPTION OF THE EMBODIMENTS

A specific embodiment of the structure of a stator according to the present disclosure will be described with reference to the accompanying drawings.

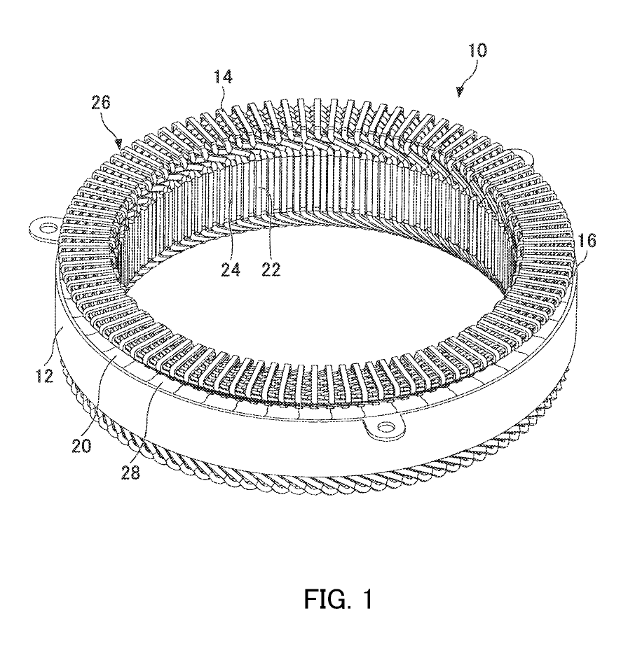

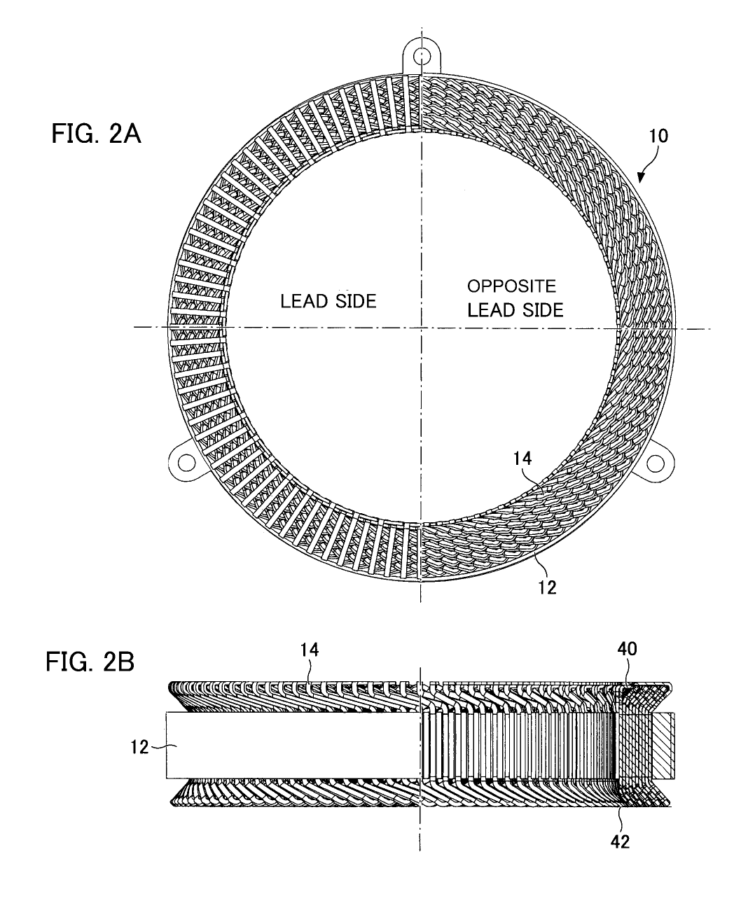

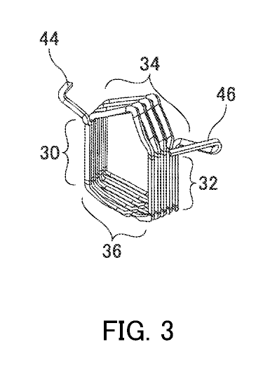

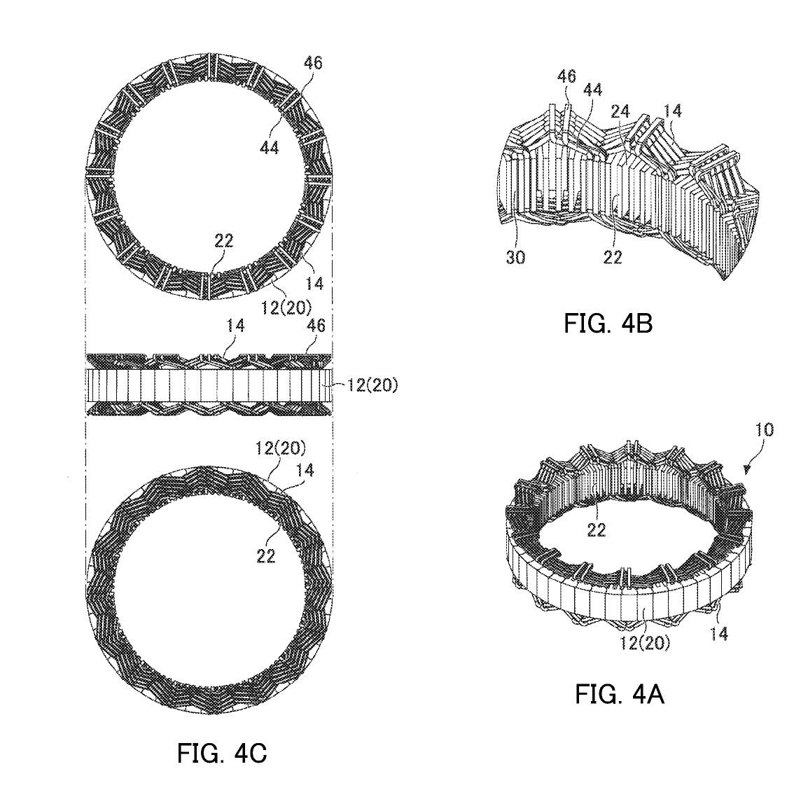

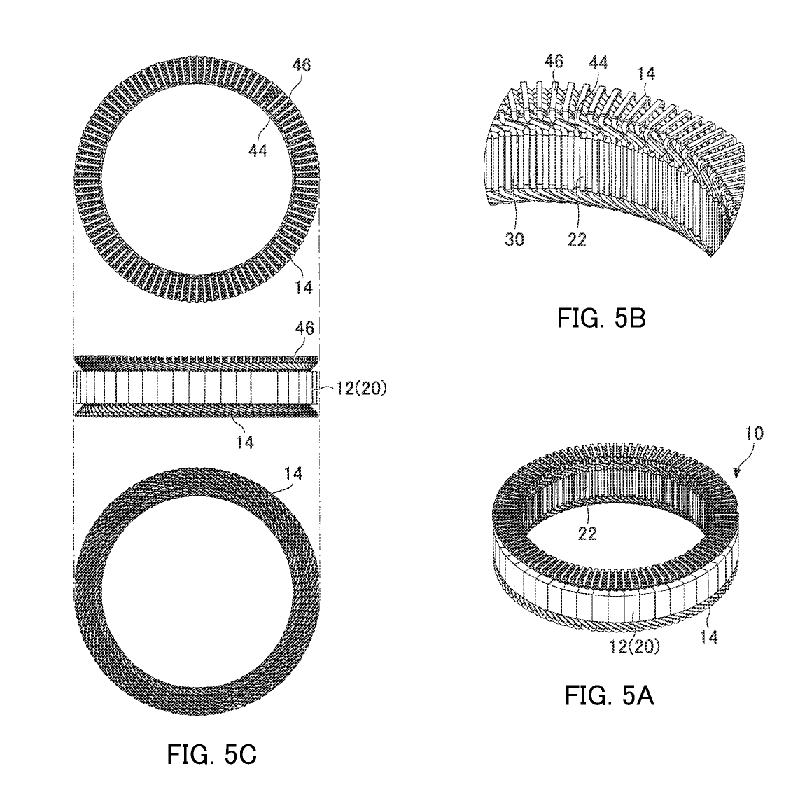

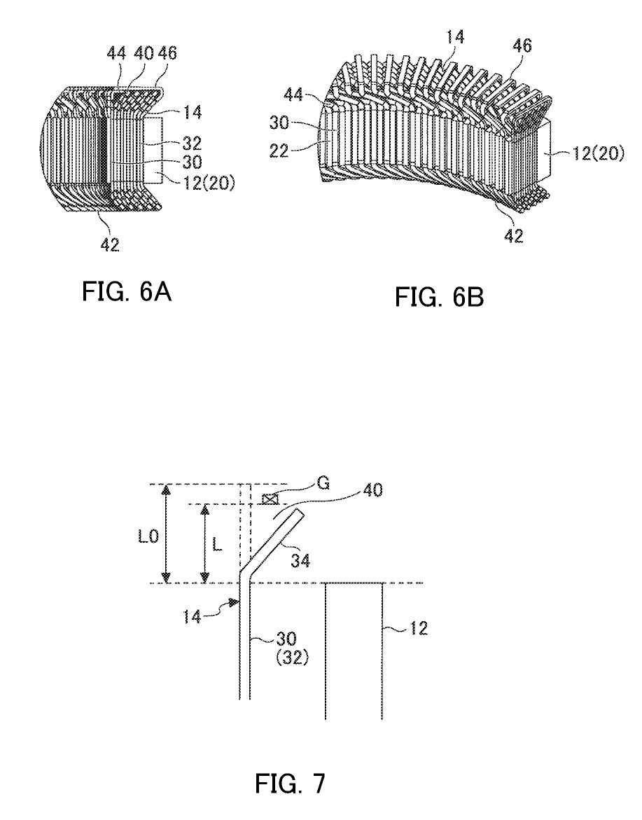

FIG. 1 is a perspective view of a stator according to an embodiment of the present disclosure. FIG. 2 shows configuration diagrams of the stator of the embodiment. FIG. 2A shows the left half of a top view and the right half of a bottom view, and FIG. 2B shows the left half of a side view and the right half of a sectional view. FIG. 3 is a perspective view of each stator coil included in the stator of the embodiment. FIG. 4 shows diagrams showing the state where a part of the stator coils has been attached to a stator core of the embodiment. FIG. 5 shows diagrams showing the state where all of the stator coils have been attached to the stator core of the embodiment. FIGS. 4A and 5A are perspective views, FIGS. 4B and 5B are enlarged perspective views of a main part, and FIGS. 4C and 5C show top, side, and bottom views. FIG. 6 shows diagrams showing the main part of the stator of the embodiment. FIG. 6A is a sectional view of the main part, and FIG. 6B is a perspective view of the main part of the stator which is shown in section in FIG. 6A. FIG. 7 is a diagram showing the positional relation in the main part of the stator of the present embodiment. FIG. 7 is a sectional view of the main part.

In the present embodiment, a stator 10 is a stationary element for use in, e.g., rotating electrical machines such as a three-phase alternating current (AC) motor. The stator 10 is placed radially outward of a rotor as a rotary element with a predetermined air gap therebetween. The stator 10 generates a magnetic field that rotates the rotor, when a current is applied thereto. The stator 10 includes a stator core 12 and stator coils 14.

The stator core 12 is a hollow cylindrical member. The stator core 12 may be formed by stacking in the axial direction a plurality of electromagnetic steel plates coated with an insulating material. A cylindrical yoke 16, which is made of compression molded soft magnetic powder coated with an insulating material, may be attached to the outer peripheral surface of the stator core 12.

The stator core 12 has an annular yoke 20 and teeth 22 protruding radially inward (toward the central axis) from the inner peripheral surface of the yoke 16. A plurality of (e.g., 96) teeth 22 are provided in the circumferential direction on the inner peripheral surface of the yoke 20 so as to be arranged at regular intervals in the circumferential direction. The stator core 12 further has slots 24 each formed between two teeth 22 which adjoin each other in the circumferential direction. The slot 24 is provided between every two of the teeth 22 which adjoin each other in the circumferential direction.

The stator coil 14 is wound around each tooth 22. A plurality of (e.g., 96) stator coils 14 are disposed in the circumferential direction radially inward of the stator core 12. The plurality of stator coils 14 disposed in the circumferential direction form a coil assembly 26. The plurality of stator coils 14 are arranged next to each other in the circumferential direction so that the coil assembly 26 has an annular shape. The coil assembly 26 is formed by arranging the slots 24 accommodating the plurality of stator coils 14 such that the slots 24 are shifted by one in the circumferential direction. In each slot 24, two stator coils 14 separated from each other by a predetermined distance in the circumferential direction are placed on top of each other in a stacking direction (i.e., radial direction) in which conductors of each stator coil 14 are stacked when wounded.

For example, in the case where the stator 10 is applied to a three-phase AC motor, each stator coil 14 forms one of U-phase, V-phase, and W-phase coils. In this case, the U-phase, V-phase, and W-phase coils as the stator coils 14 are wound around the teeth 22 in this order in the circumferential direction.

The stator core 12 is formed by a plurality of (e.g., 48) segment cores 28 in the circumferential direction. That is, the stator core 12 is divided into the plurality of segment cores 28 in the circumferential direction. Each segment core 28 has the same shape. Specifically, each segment core 28 is shaped to include a part of the yoke 20 which corresponds to the same angle in the circumferential direction, and two of the teeth 22. Insulating members that ensure insulation between the stator core 12 and the stator coils 14 are attached to the segment cores 28.

Each segment core 28 having the insulating member attached thereto is inserted radially from outside into the coil assembly 26 so that the stator coils 14 of the coil assembly 26 are placed in the slot 24 between the two teeth 22. The stator 10 comprised of the stator core 12 and the stator coils 14 is assembled by attaching all the segment cores 28 to the coil assembly 26.

The stator coil 14 is formed by a rectangular conductor having a quadrilateral (specifically, rectangular) section. The rectangular conductor need only be made of a highly conductive metal such as, e.g., copper or aluminum, and may have rounded corners. Each of the plurality of stator coils 14 disposed in the circumferential direction of the stator 10 is a concentric winding coil formed by bending the rectangular conductor wound in a predetermined plurality of (e.g., 5) turns.

Each stator coil 14 is first formed into a substantially elliptical shape wound in the predetermined plurality of turns by winding the rectangular conductor as a single straight wire around a winding jig, and is then formed into a substantially hexagonal shape wound in the predetermined plurality of turns as shown in FIG. 3 by bending the rectangular conductor formed into the substantially elliptical shape by using a forming apparatus.

Each stator coil 14 has slot portions 30, 32 and coil end portions 34, 36. The slot portions 30, 32 are portions to be accommodated in the slots 24 formed in the stator core 12. The coil end portions 34, 36 are portions protruding outward in the axial direction from both axial ends of the stator core 12. The two slot portions 30, 32 extend substantially linearly so as to extend in the axial direction through the slots 24 that are different form each other and that are separated from each other by a predetermined distance in the circumferential direction. The two coil end portions 34, 36 are located axially outward of both axial ends of the stator cores 12 and are curved so as to connect the two slot portions 30, 32 in the circumferential direction.

Both ends of each stator coil 14 protrude outward in the axial direction from the same axial end face of the stator core 12, i.e., one of both axial end faces of the stator core 12, in order to connect to other stator coils 14 or terminals. Both ends of all the stator coils 14 forming the coil assembly 26 protrude outward in the axial direction from the same axial end face of the stator core 12, i.e., one of both axial end faces of the stator core 12. Hereinafter, the “axial lead side” refers to the side from which both ends of each stator coil 14 protrude, and the “opposite axial lead side” refers to the opposite side to the axial lead side.”

The coil end portion 34 is provided on the axial lead side, and the coil end portion 36 is provided on the opposite axial lead side. Hereinafter, the coil end portion 34 is referred to as the “lead-side coil end portion 34,” and the coil end portion 36 is referred to as the “opposite lead-side coil end portion 36.” The slot portion 30 is provided on one side in the circumferential direction, and the slot portion 32 is provided on the other side in the circumferential direction. Hereinafter, the slot portion 30 is referred to as the “one-side slot portion 30,” and the slot portion 32 is referred to as the “other-side slot portion 32.”

The slot portions 30, 32 of each stator coil 14 are separated from each other in the circumferential direction by a distance corresponding to a predetermined angle. Each stator coil 14 is formed so that a plurality of rectangular conductors are stacked in the direction of the shorter side of the section of the rectangular conductor and the plurality of rectangular conductors located next to each other in the stacking direction extend parallel to each other. Each stator coil 14 is formed so that there is a predetermined clearance between the rectangular conductors adjoining each other in the stacking direction.

Each stator coil 14 is formed to have a trapezoidal section so that the distance between the slot portions 30, 32 varies according to the position in the stacking direction, namely so that the rectangular conductors located next to each other in the stacking direction in each slot portion 30, 32 are shifted each other in a direction perpendicular to the stacking direction. Each stator coil 14 is formed to have the trapezoidal section in order for the slot portions 30, 32 of the stator coil 14 to be appropriately accommodated in the slots 24 located next to each other in the circumferential direction in the annular stator core 12. Each stator coil 14 is attached to the stator core 12 so that the stacking direction of the rectangular conductors in each slot portion 30, 32 matches the radial direction of the stator core 12.

For example, in the case where the number of turns of the rectangular conductor is “5” in the stator coil 14, the number of conductors that are stacked is 5 in the one-side slot portion 30, the other-side slot portion 32, and the opposite lead-side coil end portion 36, whereas the number of conductors that are stacked is 4 in the lead-side coil end portion 34.

Each of the coil end portions 34, 36 of the stator coil 14 is formed into a plurality of different nonlinear shapes. Specifically, each of the coil end portions 34, 36 is formed into three different nonlinear shapes. Each of the coil end portions 34, 36 is formed into a crank shape so that the coil end portion 34, 36 is bent like a stair in the radial direction of the stator core 12 (crank formation), is formed into an arc shape so that the coil end portion 34, 36 is curved so as to correspond to the arc shape of the annular stator core 12 (arc formation), and is formed into a bent shape so that the coil end portion 34, 36 is bent in the longitudinal direction of the section of the rectangular conductor (edgewise formation).

The crank formation and the arc formation are bending processes that are performed in the radial direction in the stacking direction of the rectangular conductors. The edgewise formation is a bending process that is performed in the perpendicular direction perpendicular to the stacking direction of the rectangular conductors. The crank formation is a bending process that is performed at the top of the coil end portion 34, 36 in order to make a lane change between the rectangular conductors stacked in the stacking direction. The arc formation is a bending process that is performed in order to efficiently accommodate the stator coils 14 in the slots 24. The edgewise formation is a bending process that is performed in order to efficiently place the plurality of stator coils 14 to form the coil assembly 26.

A characteristic structure of the stator 10 of the present embodiment will be described below.

In the present embodiment, the coil end portions 34, 36 of each stator coil 14 are formed so as to be bent radially outward from the slot portions 30, 32 extending in the axial direction when formation of the stator coil 14 and attachment thereof to the stator core 12 are completed. That is, the coil end portion 34 is tilted radially outward (i.e., toward the yoke 20 in the radial direction) with respect to the slot portions 30, 32 extending substantially linearly in the axial direction. The coil end portion 36 is tilted radially outward (i.e., toward the yoke 20 in the radial direction) with respect to the slot portions 30, 32 extending substantially linearly in the axial direction. In this case, the tops of the coil end portions 34, 36 are located on the radially outermost side.

The coil end portions 34, 36 are tilted as described above in all of the stator coils 14 forming the coil assembly 26. Moreover, the coil end portions 34, 36 are tilted within such a range that ensures the axial coil length required for the two stator coils 14 to be placed on top of each other in each slot 24. As the coil end portions 34, 36 are tilted as described above, spaces 40, 42 are formed in regions located axially outward of the slot portions 30, 32 and radially inward of the tilted coil end portions 34, 36. Each of the spaces 40, 42 is formed in a conical, annular shape at a position axially outward of the stator core 12 on the radially innermost side of the stator core 12.

As described above, both ends of each stator coil 14 protrude outward in the axial direction from the axial end face on the axial lead side of the stator core 12. One end of each stator coil 14 is provided on the side connecting to the one-side slot portion 30, and on the radially innermost side, protrudes outward in the axial direction from the axial end face on the axial lead side of the stator core 12. The other end of each stator coil 14 is provided on the side connecting to the other-side slot portion 32, and on the radially outermost side, protrudes outward in the axial direction from the axial end face on the axial lead side of the stator core 12.

The one end of each stator coil 14 protrudes, on the radially innermost side of the one-side slot portion 30 (i.e., on the side in the radial direction on which the space 40 is formed), outward in the axial direction from the axial end face on the axial lead side of the stator core 12, and is then bent to extend toward the one side in the circumferential direction. After extending toward the one side in the circumferential direction, the one end of each stator coil 14 is bent to extend outward in the radial direction (i.e., toward the yoke 20 in the radial direction toward which the coil end portions 34, 36 are tilted). Hereinafter, the one end of each stator coil 14 is referred to as the “first bus bar portion 44.”

The other end of each stator coil 14 protrudes, on the radially outermost side of the other-side slot portion 32 (i.e., on the yoke 20 side in the radial direction toward which the coil end portions 34, 36 are tilted), outward in the axial direction from the axial end face on the axial lead side of the stator core 12, and is then bent to extend toward the other side in the circumferential direction. After extending toward the other side in the circumferential direction, the other end of each stator coil 14 is bent to extend inward in the radial direction (toward the central axis, i.e., toward the opposite side to the yoke side 20 in the radial direction toward which the coil end portions 34, 36 are tilted). Hereinafter, the other end of each stator coil 14 is referred to as the “second bus bar portion 46.” The bus bar portion 46 is formed so that its tip end is located radially outward of the lead-side coil end portion 34 of other stator coil 14 and extends inward in the radial direction across this lead-side coil end portion 34.

Each stator coil 14 is attached so that its first bus bar portion 44 is bonded to the second bus bar portion 46 of other stator coil 14 located on the one side in the circumferential direction, and its second bus bar portion 46 is bonded to the first bus bar portion 44 of other stator coil 14 located on the other side in the circumferential direction. Both ends of each stator coil 14 are bonded to the ends of other stator coils 14 by welding, an adhesive, etc. The coil assembly 16 is formed by completing attachment of all the stator coils 14 forming the coil assembly 26.

For example, in the case where the stator 10 is applied to a three-phase AC motor, the ends of two stator coils 14 of each phase are bonded so that the stator coils 14 of the same phase are connected in series, one ends of the series-connected stator coils 14 of each phase which are located in one end are connected to each other, and the other ends of the series-connected stator coils 14 of each phase which are located in the other end are connected to an external connection terminal corresponding to each phase.

Each stator coil 14 is formed so that the tip end of its first bus bar portion 44 extends outward in the radial direction and the tip end of its second bus bar portion 46 is located radially outward of the lead-side coil end portion 34 of other stator coil 14 and extends inward in the radial direction across this lead-side coil end portion 34. Bonding of the ends of two stator coils 14 is implemented by bonding the tip end of the first bus bar portion 44 of one stator coil 14 to the tip end of the second bus bar portion 46 of the other stator coil 14, and is performed between the inner peripheral end of the stator core 12 (specifically, the tip ends of the teeth 22) and the outer peripheral end of the stator core 12 (specifically, the outer peripheral end of the yoke 20).

Specifically, the first and second bus bar portions 44, 46 are formed so that the tip end of the first bus bar portion 44 which extends outward in the radial direction is located closer to the axial end face of the stator core 12 than the tip end of the second bus bar portion 44 which extends inward in the radial direction. The ends of two stator cores 14 are bonded such that the surface of the tip end of the first bus bar portion 44 of one stator coil 14 which faces outward in the axial direction contacts the surface of the tip end of the second bus bar portion 46 of the other stator coil 14 which faces inward in the axial direction. This bonding of the ends of the stator coils 14 is performed near the space 40 that is formed at the position axially outward of the stator core 12 on the radially innermost side of the stator core 12 by the tilting of the lead-side coil end portions 34. It is desirable that this bonding be performed in the space 40.

That is, as shown in FIGS. 6 and 7, bonding of one end of each stator coil 14 and the other end of other stator coil 14 is performed at a position G located on the opposite side of the coil end portion 34, which is tilted toward the yoke 20 in the radial direction with respect to the slot portions 30, 32 extending substantially linearly in the axial direction, from the yoke 20 in the radial direction. This bonding position G is such a position that the axial distance L from the axial end face of the stator core 12 to the position G is shorter than the length of the tilted part of the tilted coil end portion 34 as viewed from the side, namely the axial distance L0 from the axial end face of the stator core 12 to the top of the coil end portion 34 in the case where the tilted coil end portion 34 is not tilted.

In such a structure of the stator 10, the lead-side coil end portion 34 and the opposite lead-side coil end portion 36 of each stator coil 14 are tilted outward in the radial direction with respect to the slot portions 30, 32 extending substantially linearly in the axial direction. In this case, the axial dimension of each stator coil 14 that is attached to the stator 10 is reduced by the amount corresponding to the tilt of the coil end portions 34, 36. The present embodiment can thus reduce the overall axial length of the stator 10.

The yoke 20 of the stator core 12 is located radially outward of the stator coils 14 whose slot portions 30, 32 are accommodated in the slots 24 of the stator core 12. Accordingly, even in the structure in which the coil end portions 34, 36 of the stator coils 14 are tilted outward in the radial direction with respect to the slot portions 30, 32 as described above, the radial positions of the tip ends of the tilted parts of the stator coils 14 (i.e., the tops of the coil end portions 34, 36) can be located radially inward of the radial position of the outer peripheral surface of the stator core 12 (specifically, the yoke 20), and the tip ends of the tilted parts of the stator coils 14 can be located so as not to protrude radially outward from the radial position of the outer peripheral surface of the stator core 12.

The present embodiment can thus reduce the overall axial length of the stator 10 without increasing the radial size thereof. The stator 10 can thus be made compact, and various spaces can be used as a space that can accommodate the stator 10.

In the present embodiment, it is not necessary to change the overall length of the stator core 12 in order to reduce the overall axial length of the stator 10. In this case, a desired magnetic field can be generated in the stator 10 by applying a current to the stator coils 14. The structure of the stator 10 of the present embodiment can thus reduce the overall axial length of the stator 10 without impairing stator performance.

In the present embodiment, the coil end portions 34, 36 of each stator coil 14 are tilted toward the yoke 20 in the radial direction with respect to the slot portions 30, 32. Such a structure can avoid interference between the stator coils 14 and the rotor due to the tilting of the coil end portions 34, 36 in the radial direction, and allows the rotor to be attached to the stator 10 from either side in the axial direction of the stator core 12. It is not necessary to prepare a very large space in order to bond the ends of two stator coils 14. This can avoid reduction in ease of attachment of the rotor even though the spaces 40, 42 are formed in the radial direction on the rotor side by the tilting of the coil end portions 34, 36.

Moreover, in the present embodiment, bonding of the ends of two stator coils 14 is performed near the space 40 that is formed at the position axially outward of the stator core 12 on the radially innermost side of the stator core 12 by the tilting of the lead-side coil end portions 34. That is, this bonding is performed at such a position G that is located on the opposite side of the tilted coil end portion 34 from the yoke 20 in the radial direction, and that the axial distance L from the axial end face of the stator core 12 to the position G is shorter than the axial distance L0 from the axial end face of the stator core 12 to the top of the coil end portion 34 in the case where the tilted coil end portion 34 is not tilted.

If the tilted coil end portion 34 is not tilted, the axial distance L0 from the axial end face of the stator core 12 to the top of the coil end portion 34 is substantially equal to the length of the tilted part of the coil end portion 34 as viewed from the side, and more specifically, is equal to the sum of the length of the tilted part of the coil end portion 34 as viewed from the side and the length from the axial end face of the stator core 12 to the location where the coil end portion 34 is tilted.

In this regard, the space 40 that is formed by the tilting of the lead-side coil end portions 34 of the stator coils 14 is effectively used to bond the ends of two stator coils 14. According to the present embodiment, bonding of the ends of two stator coils 14, i.e., bonding of one end of each stator coil 14 and the other end of other stator coil 14, can thus be prevented from being performed at a position located far away in the axially and radially outward directions from the lead-side coil end portion 34. This can increase efficiency of use of the space when forming the stator 10, and can prevent an increase in size of the stator 10 and prevent an increase in overall axial length of the stator 10.

In the present embodiment, both ends of all the stator coils 14 forming the coil assembly 26 protrude outward in the axial direction from the same axial end face of the stator core 12, namely from one of both axial end faces of the stator core 12. In this regard, every stator coil 14 is bonded to other stator coils 14 on the same side in the axial direction of the stator core 12. The present embodiment can therefore improve ease of attachment when bonding the ends of the stator coils 14 and simplify the configuration of the stator 10, as compared to the configuration in which there are stator coils 14 both ends of which protrude outward in the axial direction from different axial end faces.

In the above embodiment, each stator coil 14 is formed so that the tip end of its first bus bar portion 44 extends outward in the radial direction and the tip end of its second bus bar portion 46 is located axially outward of the lead-side coil end portion 34 of other stator coil 14 and extends inward in the radial direction, and the ends of two stator coils 14 are bonded near the space 40 that is formed at the position axially outward of the stator core 12 on the radially innermost side of the stator core 12 by the tilting of the lead-side coil end portions 34. Such a configuration can reliably avoid interference between the stator coils 14 and the rotor.

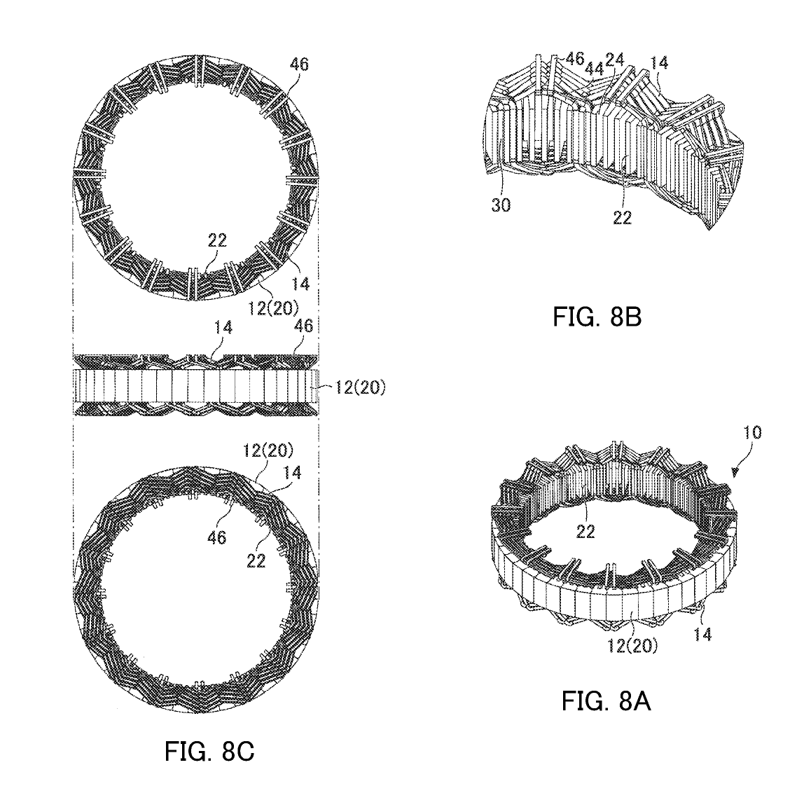

However, the present disclosure is not limited to this. As shown in FIGS. 8 to 10, as long as interference between the stator coils 14 and the rotor is avoided, each stator coil 14 may be formed so that the tip ends of the first and second bus bar portions 44, 46 extend inward in the radial direction, and as in the above embodiment, the ends of two stator coils 14 are bonded near the space 40 that is formed at the position axially outward of the stator core 12 on the radially innermost side of the stator core 12 by the tilting of the lead-side coil end portions 34.

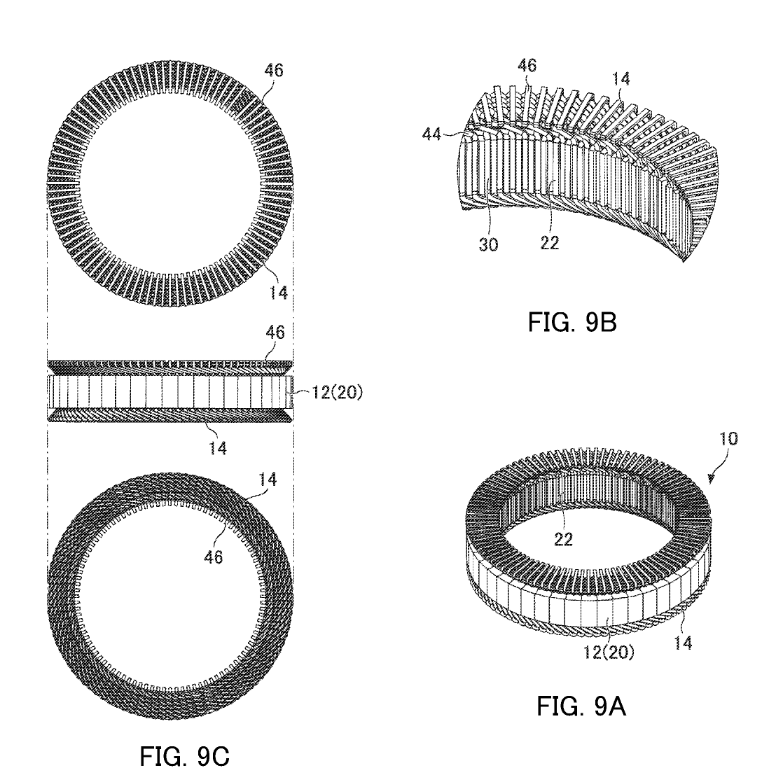

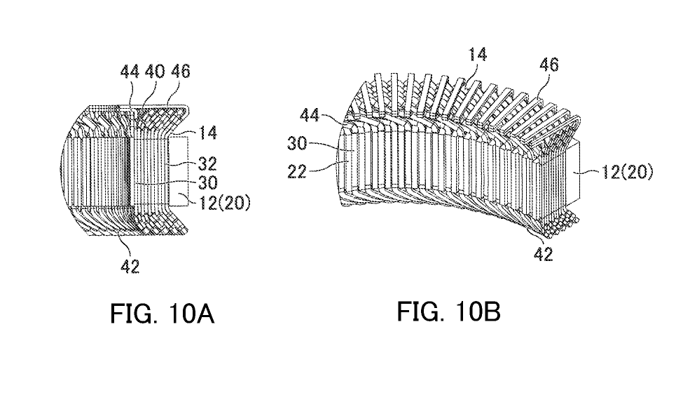

FIG. 8 shows diagrams showing the state where a part of the stator coils 14 has been attached to the stator core 12 of this modification. FIG. 9 show diagrams showing the state where all the stator coils 14 have been attached to the stator core 12 of the modification. FIGS. 8A and 9A are perspective views, FIGS. 8B and 9B show enlarged perspective views of a main part, and FIGS. 8C and 9C show top, side, and bottom views. FIG. 10 shows diagrams showing the main part of the stator 10 of the modification. FIG. 10A is a sectional view of the main part, and FIG. 10B is a perspective view of the main part of the stator 10 which is shown in section in FIG. 10A.

In such a modification, the stator coil 14 is formed so that its bus bar portion 44 extends toward one side in the circumferential direction and is then bent to extend inward in the radial direction and its second bus bar portion 46 extends toward the other side in the circumferential direction and is then bent to extend inward in the radial direction (toward the central axis) at a position axially outward of the lead-side coil end portion 34 of other stator coil 14. The ends of two stator coils 14 are bonded near the space 40 that is formed at a position axially outward of the stator core 12 on the radially innermost side of the stator core 12 by the tilting of the lead-side coil end portions 34. The modification therefore has advantageous effects similar to those of the above embodiment.

In such a modification, the tip ends of the first and second bus bar portions 44, 46 may protrude inward in the radial direction beyond the inner peripheral end of the stator core 12 (the tip ends of the teeth 22), and the ends of two stator coils 14 may be bonded at a position radially inward of the inner peripheral end of the stator core 12 (the tip ends of the teeth 12). However, the position where the ends of two stator coils 14 are bonded is located axially outward of the axial range occupied by the stator core 12 (i.e., the range between both axial end faces of the stator core 12). In this respect, even if the ends of two stator coils 14 are bonded at such a position, positioning and rotation of the rotor are not affected at all, and an appropriate magnetic circuit can be formed between the stator 10 and the rotor. Like the above embodiment, the modification can thus have predetermined advantageous effects without affecting formation of the magnetic circuit between the stator 10 and the rotor.

In the above embodiment, the coil end portions 34, 36 on both sides in the axial direction of each stator coil 14 are tilted outward in the radial direction with respect to the slot portions 30, 32. However, the present disclosure is not limited to this. Of the coil end portions 34, 36 on both sides in the axial direction of the stator coil 14, only the lead-side coil end portion 34 that is boned to the end of other stator coil 14 may be tilted outward in the radial direction with respect to the slot portions 30, 32.

In the above embodiment, both ends of all the stator coils 14 forming the coil assembly 26 protrude outward in the axial direction from the same axial end face of the stator core 12, namely from one of both axial end faces of the stator core 12, and every stator coil 14 is bonded to other stator coils 14 on the same side in the axial direction of the stator core 12. However, the present disclosure is not limited to this. Both ends of a part of all the stator coils 14 forming the coil assembly 26 may protrude outward in the axial direction from the same axial end face, namely from one of both axial end faces, and both ends of the remaining stator coils 14 may protrude outward in the axial direction from the same axial end face, namely from on the other axial end face. In this case, the ends of the part of the stator coils 14 are bonded near the space 40 that is formed at the position axially outward of the stator core 12 on the radially innermost side of the stator core 12 by the tilting of the coil end portions 34, and the ends of the remaining stator coils 14 are bonded near the space 42 that is formed at the position axially outward of the stator core 12 on the radially innermost side of the stator core 12 by the tilting of the coil end portions 36.

In the above embodiment, the coil end portions 34, 36 of each stator coil 14 are tilted outward in the radial direction (i.e., toward the yoke 20 in the radial direction) with respect to the slot portions 30, 32 extending in the axial direction, and the spaces 40, 42 associated with the tilting of the coil end portions 34, 36 are formed radially inward of the coil end portions 34, 36 (on the rotor side in the radial direction). However, the present disclosure is not limited to this. The coil end portions 34, 36 of each stator coil 14 may be tilted inward in the radial direction (i.e., toward the rotor in the radial direction) with respect to the slot portions 30, 32, and the spaces 40, 42 associated with the tilting of the coil end portions 34, 36 may be formed radially outward of the coil end portions 34, 36 (on the yoke 20 side in the radial direction).

Moreover, the above embodiment is an example in which the present disclosure is applied to an inner rotor type rotating electrical machine in which a rotor is disposed at an inner position in the radial direction and the stator 10 is disposed at an outer position in the radial direction. However, the present disclosure is not limited to this. The present disclosure may be applied to an outer rotor type rotating electrical machine in which a stator is disposed at an inner position in the radial direction and a rotor is disposed at an outer position in the radial direction.

The following will be further disclosed with respect to the above embodiment.

(1) A structure of a stator (10) including: a stator core (12) having an annular yoke (20), a plurality of teeth (22) protruding in a radial direction from a radial side surface of the yoke (20), and slots (24) each formed between two of the teeth (22) which adjoin each other in a circumferential direction; and a plurality of stator coils (14) disposed in the circumferential direction in the stator core (12), and each having two slot portions (30, 32) that are formed by a rectangular conductor having a quadrilateral section and that are accommodated in different ones of the slots (24), and coil end portions (34, 36) that are formed by the rectangular conductor and that protrude outward in an axial direction from axial end faces of the stator core (12) to connect the two slot portions (30, 32), wherein the coil end portions (34, 36) of each stator coil (14) are tilted toward the yoke (20) in the radial direction with respect to the slot portions (30, 32) extending in the axial direction, and one end of one of the stator coils (14) is bonded to the other end of another one of the stator coils (14) at such a position that is located on an opposite side of the tilted coil end portion (34) from the yoke (20) in the radial direction and that an axial distance from the axial end face of the stator core (12) to the position is shorter than that from the axial end face of the stator core (12) to a top of the coil end portion (34) in the case where the tilted coil end portion (34) is not tilted.

In the configuration of (1), the bonding of the ends of two stator coils is performed at such a position that is located on the opposite side of the coil end portion, which is tilted toward the yoke in the radial direction with respect to the slot portions extending in the axial direction, from the yoke in the radial direction and that the axial distance from the axial end face of the stator core to the position is shorter than that from the axial end face of the stator core to the top of the coil end portion in the case where the tilted coil end portion is not tilted. In this configuration, the tilting of the coil end portion can reduce the overall axial length of the stator and can maintain high stator performance. Bonding at the above position can prevent an increase in overall axial length of the stator.

(2) In the structure of the stator (10) according to (1), the bonding is performed by bonding an end of one of the stator coils (14), namely a first bus bar portion (44) that protrudes in the axial direction at a position located on an opposite side of the tilted coil end portion (34) from the yoke (20) in the radial direction, to an end of the other stator coil (14), namely a second bus bar portion (46) that protrudes in the axial direction at a position located on the yoke (20) side of the tilted coil end portion (34) in the radial direction and extends toward the opposite side to the yoke (20) side in the radial direction across the coil end portion (34).

In the configuration of (2), the bonding of the first bus bar portion of the one stator coil and the second bus bar portion of the other stator coil is performed at an appropriate position. Accordingly, bonding of the ends of two stator coils can be implemented without increasing the overall axial length of the stator.

(3) In the structure of the stator (10) according to (2), the first bus bar portion (44) protrudes in the axial direction and is bent toward the yoke (20) in the radial direction at the position located on the opposite side of the tilted coil end portion (34) from the yoke (20) in the radial direction.

In the configuration of (3), bonding between the ends of two stator coils is performed at a position closer to the yoke in the radial direction in the stator core. This can reliably avoid interference between the stator coils and the rotor.

(4) In the structure of the stator (10) according to any one of (1) to (3), at least one of the coil end portions (34, 36) on both sides in the axial direction of each stator coil (14) is tilted toward the yoke in the radial direction with respect to the slot portions (30, 32) extending the axial direction.

(5) In the structure of the stator (10) according to any one of (1) to (4), the bonding in all of the stator coils (14) is performed on the same side in the axial direction.

In the configuration of (5), ease of attachment at the time of bonding the ends of the stator coils can be improved, and the configuration of the stator can be simplified.

(6) In the structure of the stator (10) according to any one of (1) to (5), each of the teeth (22) protrudes inward in the radial direction from an inner peripheral surface of the yoke (20), and the coil end portions (34, 36) of each stator coil (14) are tilted outward in the radial direction with respect to the slot portions (30, 32) extending substantially linearly in the axial direction.

In the configuration of (6), the above advantageous effects can be implemented in the structure of the stator which is applied to a so-called inner rotor type rotating electrical machine.

(7) In the structure of the stator (10) according to any one of (1) to (6), the bonding of each of the both ends of each stator coil (14) is bonding with the end of another one of the stator coils (14) which is present in the circumferential direction.

(8) In the structure of the stator (10) according to (7), when the stator (10) is applied to a rotating electrical machine of a plurality of phases, the bonding of each of the ends of each stator coil (14) is bonding with the ends of other ones of the stator coils (14) including at least one stator coil (14) of the same phase which is present in the circumferential direction with respect to the stator coil (14).

This international application claims priority to Japanese Patent Application No. 2013-074559 filed on Mar. 29, 2013 and the entire disclosure of which is incorporated by reference herein.

1. A stator comprising:
a stator core having an annular yoke, a plurality of teeth protruding in a radial direction from a radial side surface of the yoke, and slots each formed between two of the teeth which are adjacent to each other in a circumferential direction; and
a plurality of stator coils disposed in the circumferential direction in the stator core, formed by a rectangular conductor having a quadrilateral section, and each having two slot portions that are accommodated in different ones of the slots, and coil end portions that protrude outward in an axial direction from axial end faces of the stator core to connect the two slot portions, wherein
the coil end portions of each stator coil are tilted toward the yoke in the radial direction with respect to the slot portions extending in the axial direction, and
one end of one of the stator coils is bonded to the other end of another one of the stator coils at such a position that is located on an opposite side of the tilted coil end portion from the yoke in the radial direction and that an axial distance from the axial end face of the stator core to the position is shorter than that from the axial end face of the stator core to a top of the coil end portion in the case where the tilted coil end portion is not tilted.

2. The stator according to claim 1, wherein
the bonding is performed by bonding an end of one of the stator coils, which is a first bus bar portion that protrudes in the axial direction at a position located on an opposite side of the tilted coil end portion from the yoke in the radial direction, to an end of the other stator coil, which is a second bus bar portion that protrudes in the axial direction at a position located on the yoke side of the tilted coil end portion in the radial direction and extends toward the opposite side to the yoke side in the radial direction across the coil end portion.

3. The stator according to claim 2, wherein
the first bus bar portion protrudes in the axial direction and is bent toward the yoke in the radial direction at the position located on the opposite side of the tilted coil end portion from the yoke in the radial direction.

4. The stator according to claim 1, wherein
at least one of the coil end portions on both sides in the axial direction of each stator coil is tilted toward the yoke in the radial direction with respect to the slot portions extending the axial direction.

5. The structure of the stator according to claim 1, wherein
the bonding in all of the stator coils is performed on the same side in the axial direction.

6. The structure of the stator according to claim 1, wherein
each of the teeth protrudes inward in the radial direction from an inner peripheral surface of the yoke, and
the coil end portions of each stator coil are tilted outward in the radial direction with respect to the slot portions extending substantially linearly in the axial direction.

7. The stator according to claim 1, wherein
the bonding of each of the both ends of each stator coil is bonding with the end of another one of the stator coils which is present in the circumferential direction.

8. The stator according to claim 7, wherein
when the stator is applied to a rotating electrical machine of a plurality of phases, the bonding of each of the ends of each stator coil is bonding with the ends of other ones of the stator coils including at least one stator coil of the same phase which is present in the circumferential direction with respect to the stator coil.
